(19) United States
(12) Patent Application Publication
(10) Pub. No.: US 2017/0027143 A1
(43) Pub. Date: Feb. 2, 2017

(54) Constantly Vibrating Fishing Lure

(71) Applicant: William George Vanacore, JR., Hahira, GA (US)

(72) Inventor: William George Vanacore, JR., Hahira, GA (US)

(21) Appl. No.: 15/180,205

(22) Filed: Jun. 13, 2016

Related U.S. Application Data
(60) Provisional application No. 62/197,145, filed on Jul. 27, 2015.

(51) Int. Cl. A01K 85/01

(52) U.S. Cl. CPC A01K 85/01

(57) ABSTRACT

An improved simple method to inexpensively add full time 100% vibration to both solid and hollow bodied hard plastic fishing lures. This system would use a replaceable calculator type battery that is exposed to the elements ie; water, saltwater, humidity etc. and electrically connected to a non-removable vibrator and it's wiring that's 100% sealed into the hard plastic body/insert, except for the actual battery contact tips (+& −) of said wiring that would also be exposed inside the battery retention slot and also resistant to the elements.

The present invention relates to fishing lures that give off a constant vibration regardless of position to water. IE: Top water, mid depth, deep, or on bottom. These lures make no claims as to the size, shape, type or color of the lure body. The vibrators (made by others) and their wiring are 100% sealed in solid hard plastic to prevent replacement as well as keep all contaminants, water, air, saltwater or moisture of any kind from coming in contact with the wiring or vibrator. As with all lures it could have at least one eyelet for connecting fishing line and could have more for extra lines or addition of hook or hooks. The hook or hooks could also be built into the lure body. The actual battery is replaceable and exposed to the elements. The battery would make contact to the end of the vibrator wires which would also be exposed and made of a material to resist corrosion (stainless steel type contacts). The battery would also be exposed to all elements such as air, water, liquids, saltwater and any form of moisture. The battery would be secured in place only by the friction from the contact against the wire ends of the vibrator in the battery slot of the lure body. These lures would not have any switch or switches as the removal of the battery would stop it from vibrating and installing the battery would turn on the vibration.

Most all electric vibrating type lures on the market today are intermittent at best or controlled by switches and or sensors (circuit boards) to turn on when in the water or come on if a certain uncontrollable angle might be achieved. This is a new useful process and improvement over what is on the market today.

### BACKGROUND OF THE INVENTION

The present invention relates to an improved method/system for adding 100% full time (not intermittent, part time or controlled by a switch) vibration to hard bodied fishing lures.

The main specific improvements are the vibrator and non-exposed wiring are both sealed 100% from any contaminants (water, moisture, etc.) in solid hard plastic.

Another improvement is that the battery and the exposed tips of the corrosion resistant vibrator wires that contact the battery (+&−) are 100% exposed to said elements. The battery simply slides into a battery retention slot to turn on vibration and removed to stop. Nothing to unscrew, take apart or put together especially with wet hands while fishing or in the rain.

### SUMMARY OF THE INVENTION

The present invention relates to a improved method or procedure for adding electrical vibration to a hard bodied fishing lure. By enclosing the vibrator and wiring in solid hard plastic it keeps the vibrator from deteriorating when coming in contact with any form of moisture, from water, saltwater, fish slime, humidity etc. This adds substantial life and extended use to the fishing lure. The use of the battery retention slot that leaves the battery 100% exposed to the elements and makes changing it out simple and quick, approximately 2 seconds or less. These batteries last about 45 minuets and are relatively cheap/inexpensive to purchase locally. This also allows the lure to vibrate 100% all the time with a charged installed battery and not intermittently or maybe sometimes when a required awkward angle is needed that may never be attained.

### BRIEF DESCRIPTION OF THE DRAWINGS

FIG. 1 is a perspective view of the Hard Plastic Body/Insert.

FIG. 4-4 is a side/edge view of battery retention slot in FIG. 1

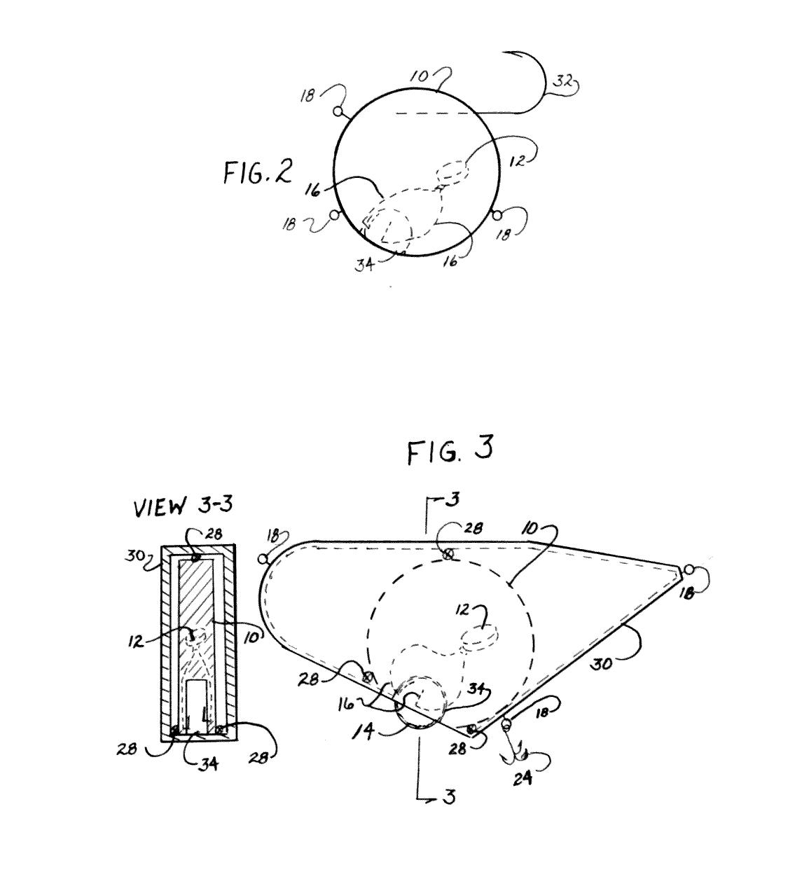

FIG. 2 is the side view of the Hard Plastic Body/Insert with addition of eyelet(s) and a hook(s) making it a fishing lure.

FIG. 3 is the Hard Plastic Body/Insert permanently sealed and non-removable from inside a Hollow Bodied Lure.

FIG. 3-3 is a section view of the Hard Plastic Body/Insert permanently sealed inside of a Hollow Bodied Lure.

### DETAILED DESCRIPTION OF THE INVENTION

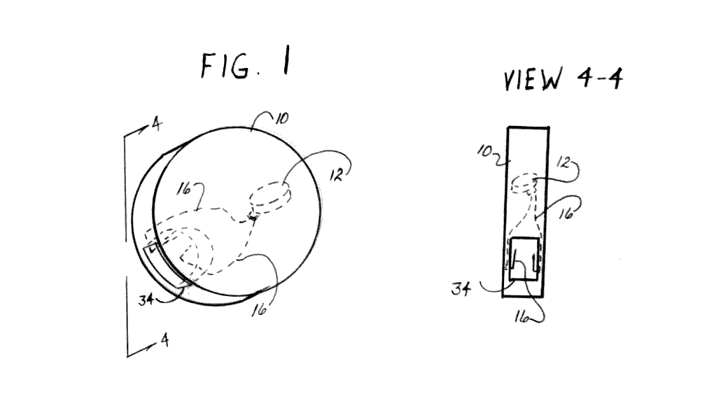

The following detailed description is of the best contemplated modes of carrying out exemplary embodiments of the invention. The description is not to be taken in a limiting sense, but is made merely for the purpose of illustrating the general principles of the invention, since the scope of the invention is best defined by the appended claims.
1. Broadly, an embodiment of the present invention of FIG. 1 would be this improved system or method of making a hard plastic body/insert 10 that would have a completely 100% sealed non-removable non-replaceable vibrator 12 and wiring harness 16 and a completely exposed battery 14 held in the battery retention slot 34 by the exposed ends of the wiring harness that would be made of corrosion resistant wire. These wires 16 could be 100% corrosion resistant or just have the exposed tips sticking into the battery retention slot corrosion resistant.
2. As shown in FIG. 2 the addition of a hook(s) 32 and/or eyelet(s) 18 too the hard plastic body/insert 10 and it would become a battery powered vibrating lure.
3. Or as shown in FIG. 3 the hard plastic body/insert 10 could be permanently secured with plastic/glue 28 as shown in view 3-3 into a hollow bodied lure 30 FIG. 3 and make that lure vibrate.

It should be understood, of course, that the foregoing relates to exemplary embodiments of the invention and that modifications may be made without departing from the spirit and scope of the invention as set forth in the following claims.

What is claimed is:

1. An improved system or method of adding 100% full time vibration to hard bodied fishing lures, comprising:
A vibrator and it's wiring harness that is 100% sealed from all elements (moisture) in a hard plastic body/insert including a battery retention slot.
A calculator type battery that is 100% exposed to all elements (saltwater, freshwater, humidity and moisture of any kind)and can be slid into the battery retention slot.
The exposed ends of the wires from the vibrator that are exposed in the battery retention slot would be resistant to the elements(moisture, etc.) and could be resistant their entire length back to the vibrator, or connected to said vibrator wires at any concealed sealed point along wires inside the hard plastic body/insert.
When the battery is installed would turn on vibrations and when removed the vibrations would stop.

2. The device of claim 1, which could have a hook(s) or eyelet(s) added which would make the hard plastic body/insert a fishing lure.

3. The device of claim 1, which when the hard plastic body/insert is securely and permanently attached to the inside of any hollow bodied lure. Could cause said lure to vibrate.
